(19) United States
(12) Patent Application Publication
(10) Pub. No.: US 2022/0106991 A1
(43) Pub. Date: Apr. 7, 2022

(54) Bearing Assembly for Translator of Linear Actuator of Clutch Assembly

(71) Applicant: Means Industries, Inc., Saginaw, MI (US)

(72) Inventors: Brandon J. Voelker, Westland, MI (US); Scott D. Bostian, Kingston, MI (US); Carl Thomas Beiser, Frankenmuth, MI (US)

(73) Assignee: Means Industries, Inc., Saginaw, MI (US)

(21) Appl. No.: 17/490,336

(22) Filed: Sep. 30, 2021

Related U.S. Application Data
(60) Provisional application No. 63/088,092, filed on Oct. 6, 2020.

(51) Int. Cl. F16D 41/067; F16D 28/00

(52) U.S. Cl. CPC F16D 41/067; F16D 28/00

(57) ABSTRACT

A clutch assembly includes a hub, a linear actuator, and a bearing assembly. The hub is rotatable about a rotational axis. The linear actuator has a translator mounted concentrically over the hub. The bearing assembly is at an interface between the translator and the hub. The bearing assembly permits transmission of torque between the translator and the hub while allowing for axial movement of the translator in a direction along the rotational axis relative to the hub. The bearing assembly includes a rolling element(s) (e.g., ball bearing, ball, roller, needle). The bearing assembly may further include a (full circumference, or divided segment) cage which entraps the rolling element(s). The clutch assembly may further include a coupling member supported for rotation about the rotational axis. The hub, with the translator concentrically mounted thereon, is mounted concentrically over a portion of the coupling member.

### CROSS-REFERENCE TO RELATED APPLICATIONS

This application claims the benefit of U.S. Provisional Application No. 63/088,092, filed Oct. 6, 2020, the disclosure of which is hereby incorporated in its entirety by reference herein.

### TECHNICAL FIELD

The present invention relates to automotive clutch assemblies and, more particularly, to a translator of a linear actuator operable for controlling coupling members of such clutch assemblies.

### BACKGROUND

A one-way clutch (“OWC”) includes a first coupling (or clutch) member, a second coupling member, and at least one locking element (or locking member) between opposing surfaces of the coupling members. The locking element is movable between (i) a deployed (or engaged) position in which the locking element extends from the first coupling member and engages the second coupling member and (ii) a non-deployed (or disengaged) position in which the locking element does not extend from the first coupling member and does not engage the second coupling member. When the locking element is in the deployed position and engages the second coupling member, the OWC locks in one direction of rotation but has free rotation in the opposite direction. Two types of OWCs often used in vehicular, automatic transmissions include roller type clutches, which can include spring-loaded rollers between inner and outer races of the OWC, and sprag type clutches, which can include asymmetrically shaped wedges located between inner and outer races of the OWC.

A selectable OWC (“SOWC”) (also known as a two-way clutch) further includes a second set of locking elements in combination with a selector plate to add multiple functions to the OWC. A SOWC can produce a mechanical connection between rotating or stationary input/output power flow components (e.g., input/output shafts respectively connected to the coupling members) in one or both directions and can overrun in one or both directions. A SOWC contains an externally controlled selection mechanism movable between positions for adjusting the selector plate to different corresponding operating modes of the SOWC.

Dynamic clutches are clutch assemblies in which the first and second coupling members are both rotatable. A Dynamic Controllable Clutch (or dynamic selectable clutch) (“DCC”) packages in dynamic clutch positions where typically dog clutches, synchronizers, and wet friction packs would be located. Using electric actuation, the DCC eliminates the need for hydraulic systems and creates substantial packaging and system efficiency benefits. Particularly, as discussed herein, a DCC uses a type of actuation system involving a linear actuator which can control the locking elements while either or both coupling members are rotating.

Referring now to FIGS. 1A, 1B, 1C, 1D, and 1E (collectively “FIGS. 1”), a DCC 12 in accordance with the prior art will be described. DCC 12 is a component of a system (not shown), such as an automotive transmission, further having an input power flow component (e.g., a drive gear) and an output power flow component (e.g., a driven shaft).

DCC 12 has a radially inner rotating race, i.e., a first coupling member in the form of a pocket plate 13, and a radially outer rotating race, i.e., a second coupling member in the form of a notch plate 16. Pocket plate 13 is fixedly connected to a first power flow component of the system and notch plate 16 is fixedly connected to a second power flow component of the system. Consequently, the first and second power flow components are connected when pocket and notch plates 13 and 16 are connected.

Pocket plate 13 contains first and second sets of radial locking elements 26 for clockwise (“CW”) and counterclockwise (“CCW”) engagement, respectively. During engagement, at least one of locking elements 26 simultaneously contacts pocket and notch engagement faces of pocket and notch plates 13 and 16, respectively, which thereby connects the pocket and notch plates together. The connection of pocket and notch plates 13 and 16 together connects the first and second power flow components together. Consequently, in each locked direction of rotation, DCC 12 can transmit torque between the power flow components, which are connected together via the connected pocket and notch plates 13 and 16.

DCC 12 is electrically actuated by an actuation system in the form of a linear motor (“linear actuator”) 14. Linear actuator 14 includes a stator 22 and a translator 20. Stator 22 is fixed in position such as being fixed to a transmission case (not shown) via mounts 47. Stator 22 includes a pair of copper wire induction coils 44 and 46. Steel plates 48, 50, and 52 provide a housing for stator coils 44 and 46. Stator coils 44 and 46 are wound in series with reversed polarity relative to one another (anti-series).

Translator 20 is linearly movable between lateral (i.e., axial) positions. Translator 20 is fixedly connected to and rotates with pocket plate 13. (Alternatively, in a variation, translator 20 is fixedly connected to and rotates with notch plate 16.) Translator 20 includes an annular ring of segmented permanent magnets 21, steel plates 23 and 25, and rigid (or spring-loaded) plungers 30. Plungers 30 operate locking elements 26. Plungers 30 extend through holes formed through a carriage 51 of translator 20 and are biased by apply springs 34. Plungers 30 are threaded at their ends and secured within their holes by internally threaded nuts 35. Conical ends of plungers 30 extend through apertures of a ring 55.

FIGS. 1B, 1C, 1D, and 1E detail how linear actuator 14 controls locking elements 26. Linear actuator 14 can control locking elements 26 while pocket plate 13 and notch plate 16 are rotating. Plungers 30 within translator 20 directly contact locking elements 26 and cause them to pitch up or pitch down depending on actuation direction. Linear actuator 14 has an “off” position (shown in FIGS. 1B and 1D) and an “on” position (shown in FIGS. 1C and 1E). Linear actuator 14 switches between the “off” and “on” positions by causing translator 20 to laterally move between, in this case, a right-most position (shown in FIGS. 1B and 1D) and a left-most position (shown in FIGS. 1C and 1E).

When translator 20 moves from “off” to “on”, each plunger 30 contacts the under face or surface of its locking element 26 so the locking element can engage into notch plate 16. DCC 12 can transmit torque in each locked direction of rotation when locking elements 26 are engaged with notch plate 16. A return spring 28 under each locking element 26 is compressed during the engaged state. When commanded “off”, translator 20 moves back toward the “off” position and plungers 30 lose contact with locking elements 26. Compressed return springs 28 create a force that causes locking elements 26 to pitch downward or disengage. Once a torque reversal occurs, locking elements 26 can disengage and DCC 12 can freewheel.

To change state from “off” to “on”, electrical current energizes stator coil 46 nearest to translator 20. Energized induction coil 46 produces a magnetic field which repels the steady state field generated by permanent magnets 21 while far stator coil 44 produces an attractive magnetic field. The combination of repelling and attracting forces caused by stator coils 44 and 46 causes translator 20 to move.

Once translator 20 passes over center stator steel plate 50, permanent magnet 21 attempts to fully align leftmost stator steel plate 48. However, a mechanical stop 53 (FIGS. 1D and 1E) prevents full alignment, which results in a biasing force that holds translator 20 in the “on” position. Translator 20 is magnetically latched in the “on” position.

To disengage DCC 12, current is applied to stator coil 44 nearest to translator 20 (formerly far stator coil 46) and linear actuator 14 moves from the “on” stop 53 to a ring which functions as an “off” stop 42 in a similar manner described above. The “off” mechanical stop 42 prevents full alignment of permanent magnet 21 and rightmost stator steel plate 52, remaining magnetically latched in the “off” position.

### SUMMARY

An object of the present invention is a bearing assembly for a translator of a linear actuator of a clutch assembly.

Another object of the present invention is a linear bearing assembly for axial translation of a mechanical actuator in a clutch assembly.

In carrying out at least one of the above and/or other objects, a clutch assembly having a hub, a linear actuator, and a bearing assembly is provided. The hub is rotatable about a rotational axis. The linear actuator has a translator mounted concentrically over the hub. The bearing assembly is at an interface between the translator and the hub. The bearing assembly permits a transmission of torque between the translator and the hub while allowing for axial movement of the translator in a direction along the rotational axis relative to the hub. The bearing assembly includes at least one rolling element.

The at least one rolling element may be a ball bearing, a ball, a roller, or a needle.

The bearing assembly may further include a cage. In this case, the at least one rolling element is entrapped by the cage.

The cage may encompass a full circumference of the interface between the translator and the hub. In this case, the cage may include a plurality of raceways, with at least one of the raceways having at least one rolling element retained therein. Some embodiments specifically provided for having at least three raceways. The at least one of the raceways may have two or more rolling elements retained therein.

The cage may be divided into individual cage segments. In this case, each cage segment includes a raceway, with at least one of the raceways having at least one rolling element retained therein. The at least one of the raceways may have two or more rolling elements retained therein.

The linear actuator may further include a stator having a stator coil. In this case, the translator is arranged adjacent to the stator and is axially movable, depending on polarity of electrical current of the stator coil, relative to the hub in the direction along the rotational axis between at least first and second positions.

The clutch assembly may further include a coupling member supported for rotation about the rotational axis. The hub, with the translator concentrically mounted thereon, is mounted concentrically over a portion of the coupling member. In this case, the translator is axially movable relative to the hub and the portion of the coupling member in the direction along the rotational axis between at least first and second positions. The coupling member may be a pocket plate or a notch plate.

Further, in carrying out at least one of the above and/or other objects, a clutch assembly having first and second coupling members, a hub, a linear actuator, and a bearing assembly is provided. The coupling members are supported for rotation relative to one another about a rotational axis. At least one locking member is provided for selectively mechanically coupling the coupling members together to prevent relative rotation of the coupling members with respect to each other in at least one direction about the rotational axis.

The hub is mounted concentrically over a portion of the first coupling member and is rotatable about the rotational axis.

The linear actuator has a stator and a translator. The stator includes a stator coil to create a magnetic flux when the stator coil is energized with electrical current. The translator is arranged adjacent to the stator and mounted concentrically over the hub and is rotatable about the rotational axis.

The bearing assembly is at an interface between the translator and the hub. The bearing assembly permits a transmission of torque between the translator and the hub while allowing for axial movement of the translator relative to the hub in a direction along the rotational axis. The bearing assembly includes at least one rolling element.

The translator is axially movable, depending on polarity of electrical current of the stator coil, relative to the hub in the direction along the rotational axis between at least first and second positions. The translator is further configured to move the at least one locking member as the translator moves between the first and second positions whereby the first and second positions correspond to first and second operating modes of the coupling members.

The first coupling member may be a pocket plate and the second coupling member may be a notch plate. Alternatively, the first coupling member may be a notch plate and the second coupling member may be a pocket plate.

### BRIEF DESCRIPTION OF THE DRAWINGS

FIG. 1A illustrates an exploded view of a dynamic controllable clutch (“DCC”) in accordance with the prior art, the DCC having a linear actuator operable for controlling coupling members of the DCC;

FIG. 1B illustrates a perspective view, partially broken away and in cross section, of the DCC with the linear actuator being in an “off” position whereby the DCC is in a free wheel mode;

FIG. 1C illustrates a perspective view, partially broken away and in cross section, of the DCC with the linear actuator being in an “on” position whereby the DCC is in a lock mode;

FIG. 1D illustrates a side view, partially broken away and in cross section, of the DCC with a translator of the linear actuator being magnetically latched in the “off” position, wherein FIGS. 1B and 1D pertain to the same condition of the DCC;

FIG. 1E illustrates a side view, partially broken away and in cross section, of the DCC with the translator of the linear actuator being magnetically latched in the “on” position, wherein FIGS. 1C and 1E pertain to the same condition of the DCC;

FIG. 2A illustrates a perspective view of a bearing assembly in accordance with embodiments of the present invention for the translator of the linear actuator, the bearing assembly fitting concentrically over and mounted to a hub that is provided between the translator and a coupling member of the DCC;

FIG. 2B illustrates a plan view of the translator, the hub, and the bearing assembly in an assembled state, the bearing assembly being positioned along the translator/hub interface in the assembled state;

FIG. 2C illustrates an enlarged, sectional plan view of FIG. 2B;

FIG. 2D illustrates a sectional side view of the translator, the hub, and the bearing assembly in the assembled state;

FIG. 3A illustrates an individual part view of the hub, the translator, and a snap ring and a balls/cage component of a bearing assembly in accordance with embodiments of the present invention;

FIG. 3B illustrates a perspective view of the hub and the bearing assembly in the assembled state;

FIG. 3C illustrates an enlarged view of the translator, the hub, and the balls/cage component of the bearing assembly in the assembled state with the snap ring of the bearing assembly not being shown;

FIG. 3D illustrates a perspective view of the translator, the hub, and the bearing assembly in the assembled state;

FIG. 4A illustrates a perspective view of the hub and a bearing assembly in accordance with embodiments of the present invention in the assembled state;

FIG. 4B illustrates a perspective view of the translator, the hub, and the bearing assembly in the assembled state;

FIG. 4C illustrates a perspective view of the translator, the hub, and the bearing assembly in the assembled state with a force applied at the outer diameter of the translator representing an unrealistic worse case loading condition to result in binding;

FIG. 4D illustrates a perspective view of the translator, the hub, and the bearing assembly in the assembled state with a continued application of the force resulting in un-bound motion of the translator;

FIG. 5A illustrates a top view of a bearing assembly in accordance with embodiments of the present invention;

FIG. 5B illustrates a section view of the bearing assembly;

FIG. 5C illustrates a top view of the translator, the hub, and the bearing assembly in the assembled state;

FIG. 5D illustrates a cross-sectional plan view of the translator, the hub, and the bearing assembly in the assembled state;

FIGS. 6A, 6B, 6C, 6D, and 6E illustrates respective drawings of a ball bearing of the bearing assembly between the translator and the hub that are depictive of various information as described herein;

FIG. 7 illustrates a cross-sectional view of a clutch assembly having a bearing assembly in accordance with embodiments of the present invention; and

FIG. 8 illustrates a cross-sectional view of the DCC having a bearing assembly in accordance with embodiments of the present invention.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

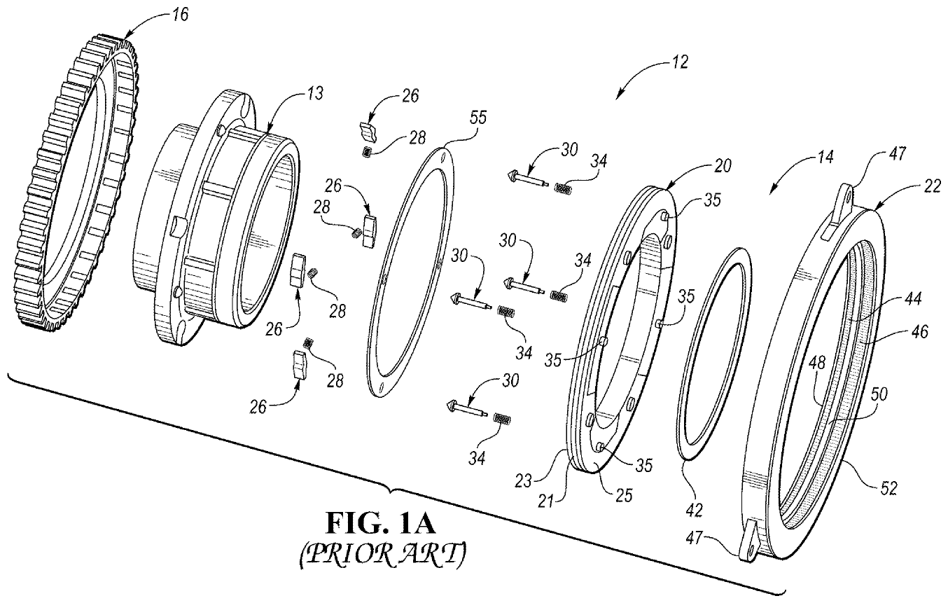

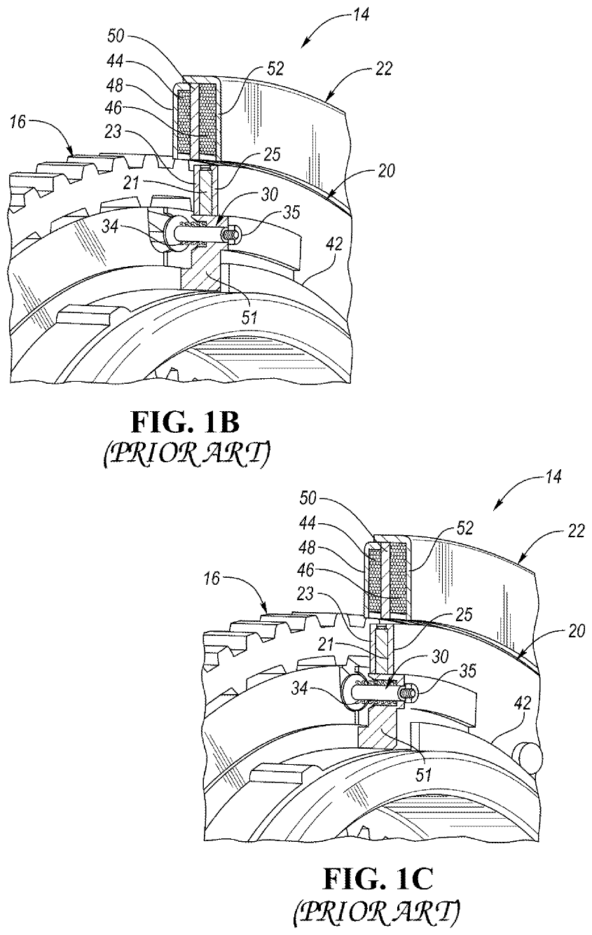

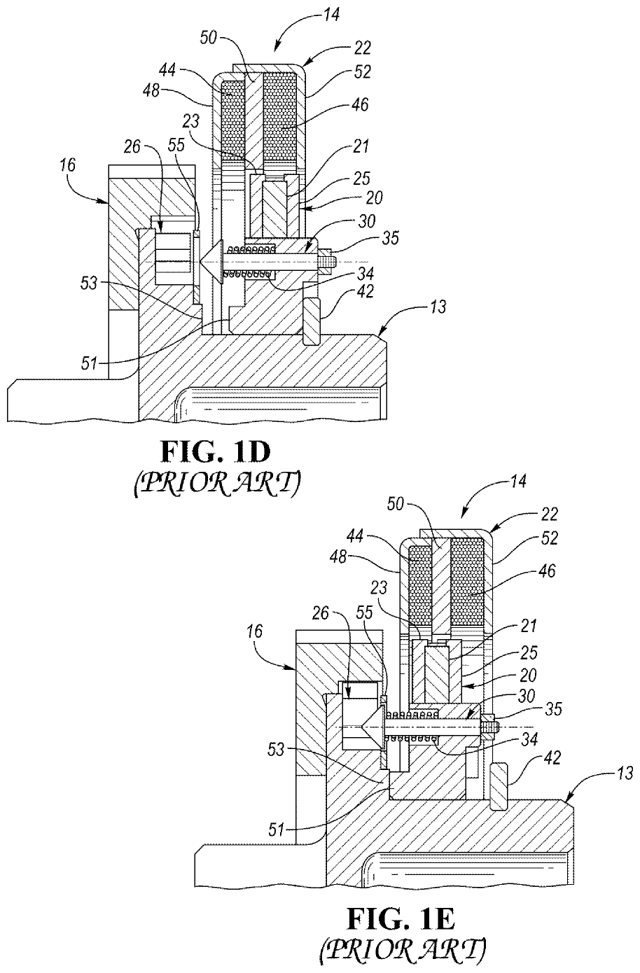

As set forth above, FIG. 1 illustrate a DCC 12 in accordance with the prior art. As described, DCC 12 has first and second coupling members in the form of pocket plate 13 and notch plate 16 and further has linear actuator 14, which includes translator 20 and stator 22 that are operable for controlling the coupling members.

As described and as shown in FIG. 1, translator 20 is assembled to and rotates with pocket plate 13 and is axially movable along pocket plate 13. In this regard, a hub is provided between carriage 51 of translator 20 and pocket plate 13. The hub fits concentrically over pocket plate 13 and is splined to the pocket plate to rotate therewith. Translator 20 fits concentrically over the hub and has a fixed connection thereto. Further, the hub slidably supports translator 20 to move axially during corresponding shifting movement, such as shown in FIGS. 1D and 1E.

Translator 20 must be capable of relative movement in the axial direction with respect to the hub with very low resistance. However, translator 20 must also be able to transmit rotational torque to the hub. To permit the transmission of torque between translator 20 and the hub, while allowing for relative axial movement between translator 20 and the hub, an inventive bearing assembly is utilized at the translator/hub interface.

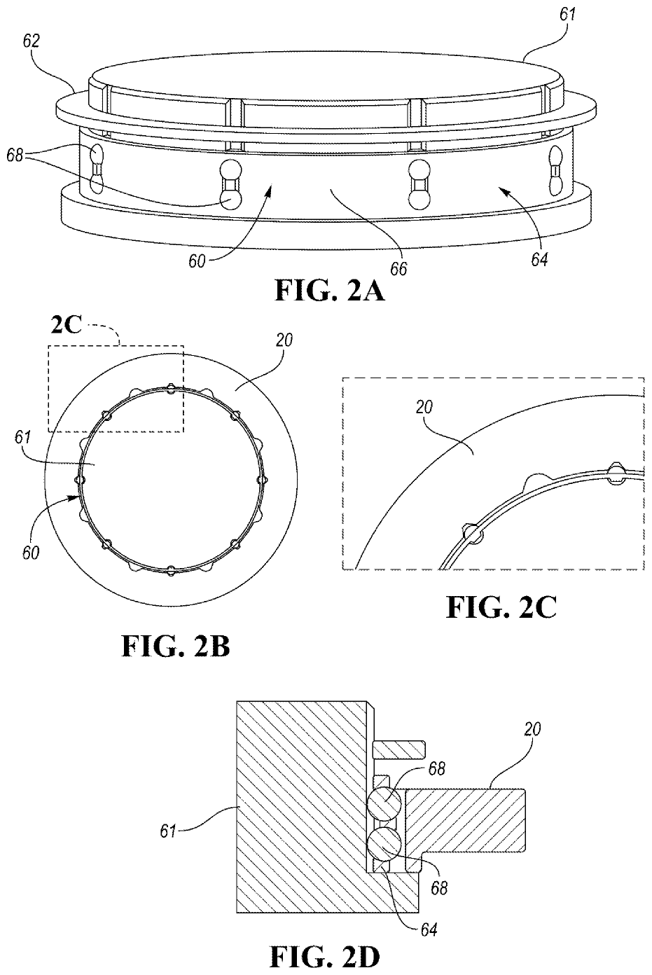

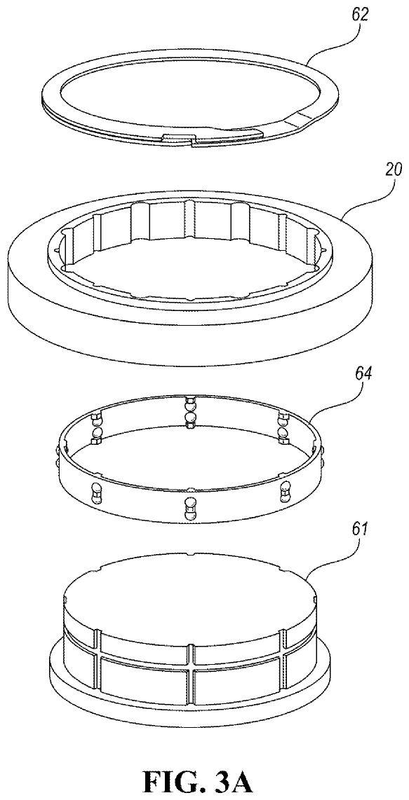

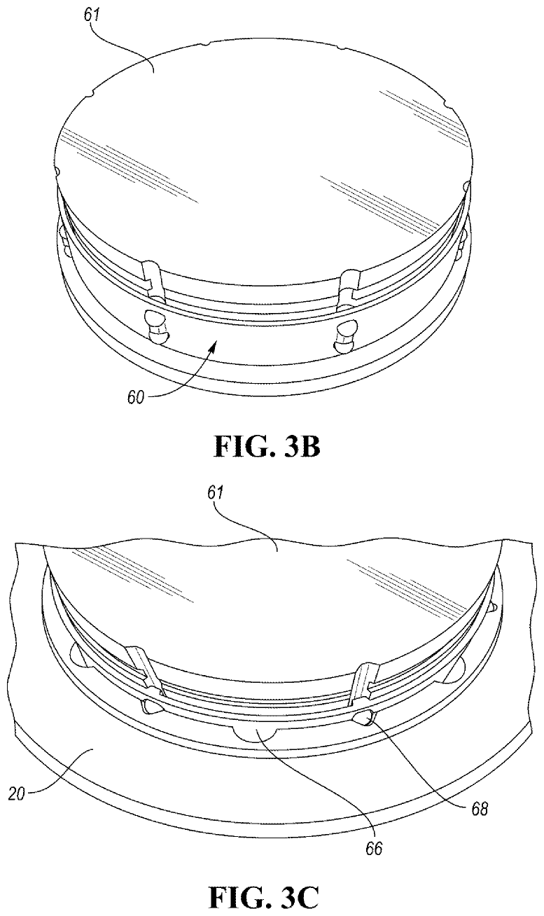

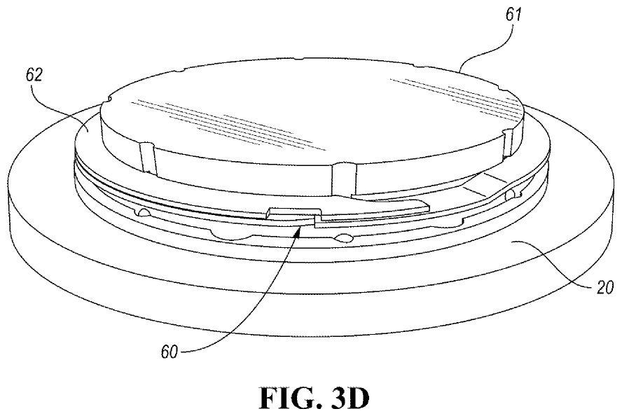

Referring now to FIGS. 2A, 2B, 2C, and 2D and FIGS. 3A, 3B, 3C, and 3D, a bearing assembly 60 in accordance with embodiments of the present invention is shown. As shown in FIG. 2A, bearing assembly 60 fits concentrically over and is mounted to a hub 61. Bearing assembly 60 is positioned along an interface between translator 20 and hub 61 (the “translator/hub interface”) in an assembled state of the translator, the hub, and the bearing assembly, which assembled state is shown in FIGS. 2B, 2C, and 2D.

An individual part view of hub 61, translator 20, and a snap ring 62 and a balls/cage component 64 of bearing assembly 60 is shown in FIG. 3A. Balls/cage component 64 includes a cage 66 in the form of an annular ring with ball bearings 68 retained in pockets thereto. FIG. 3B is a perspective view of hub 61 and bearing assembly 60 in the assembled state. Ball bearings 68 are retained in cage 66 via pockets and are shown in position over hub 61. FIG. 3C is an enlarged view of translator 20, hub 61, and balls/cage component 64 of bearing assembly 60 in the assembled state with snap ring 62 of the bearing assembly not being shown. As snap ring 62 is now shown, the internal rolling elements are viewable. FIG. 3D is a perspective view of translator 20, hub 61, and bearing assembly 60 in the assembled state.

Bearing assembly 60 provides linear guidance to translator 20 via ball bearings 68. The theory is that linear actuation via ball bearings 68 results in rolling friction at the translator/hub interface as compared to sliding with pins/splines. This fundamentally changes the operating parameters and greatly increases the available L/D (Length-to-Diameter ratio).

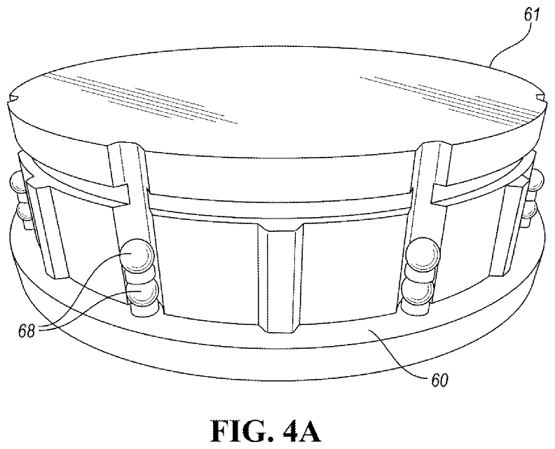

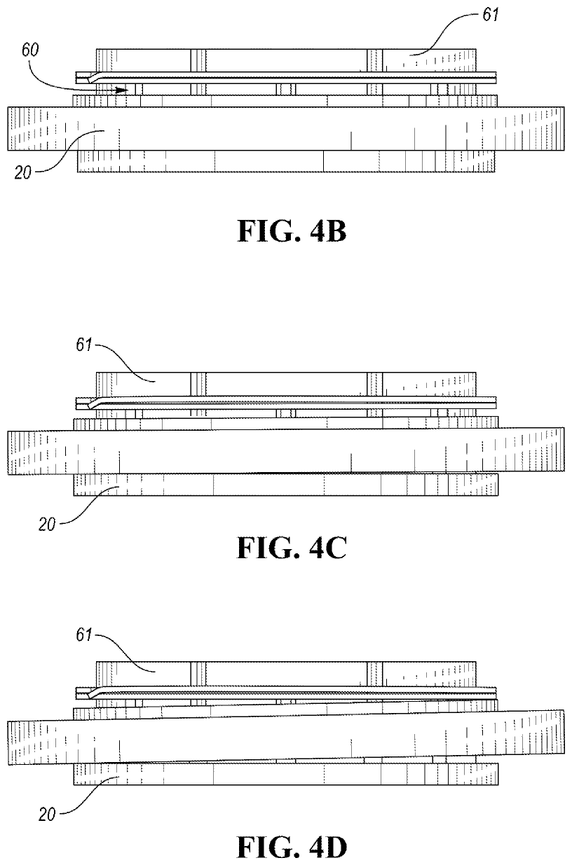

A hand model validation is a subject of FIGS. 4A, 4B, 4C, and 4D. Regarding the hand model validation, testing of the pin/spline interface resulted in large counterforce to un-cock a translator that had become bound due to a one-sided load. In accordance with embodiments of the present invention, testing of the ball bearing design was completed via a retrofit of a five mm pin design, using two five mm balls 68 in each raceway between translator 20 and hub 61.

FIG. 4A is a perspective view of hub 61 and bearing assembly 60 in the assembled state pursuant to the retrofit. In FIG. 4B, translator 20 is at rest with ball bearings 68 and spacers loaded into all of the raceways (there being eight raceways total; of course, more or less than eight raceways total may be provided). In FIG. 4C, a force is applied at the outer diameter (OD) of translator 20. This force represents an unrealistic worse case loading condition which would result in binding. In response to this force, translator 20 tips due to the radial spacing, as shown in FIG. 4C. In FIG. 4D, continued application of the force results in un-bound motion of translator 20. There is zero counter force required to move the opposing side of translator 20. As illustrated, this retrofit design is capable of translating from one-sided force without binding.

Turning back to FIGS. 2A, 2B, 2C, and 2D, design features therein include using five mm steel balls 68 (there being sixteen total balls and eight raceways with each raceway having two balls; of course, other diameter sized balls 68 may be used). Balls 68 are retained via continuous cage 66. Cage 66 is designed such that balls 68 are always retained under translator 20 and are able to translate in pure rotation. The pin slot geometry on hub 61 and translator 20 may be reused for retrofit. Although such grooves are not optimized, they may be sufficient for some applications.

The validation provides a confirmation of unbound motion in that the model in accordance with embodiments of the present invention can translate in a static state from a one-sided force without binding. Regarding translation of the rolling elements, during translation the caged retainer can be observed traveling the full stroke required to keep the balls in rolling condition when loaded. The force required to translate (one-sided load) is on the order of three to six N for horizontal and one N for vertical.

Another model in accordance with embodiments of the present invention uses optimized ball specific raceways instead of reusing the pin grooves.

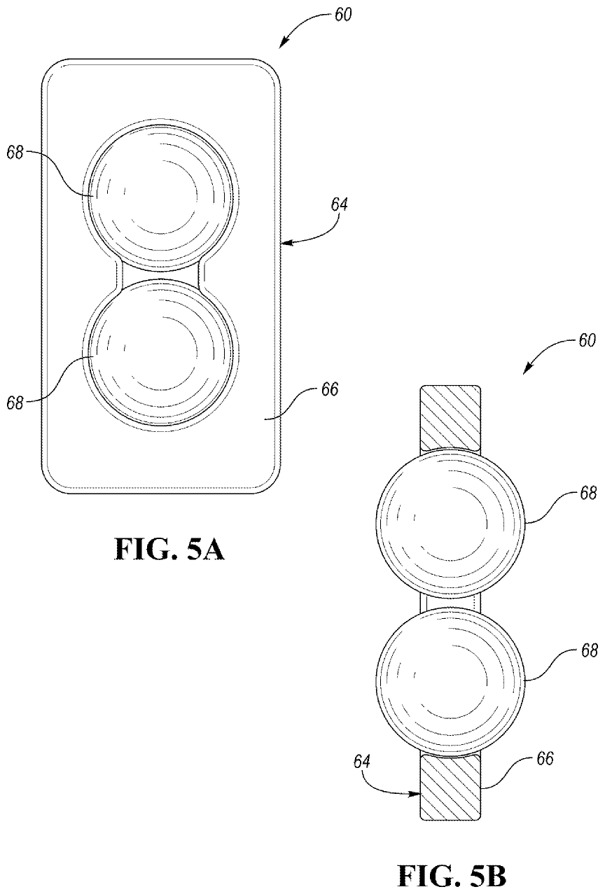

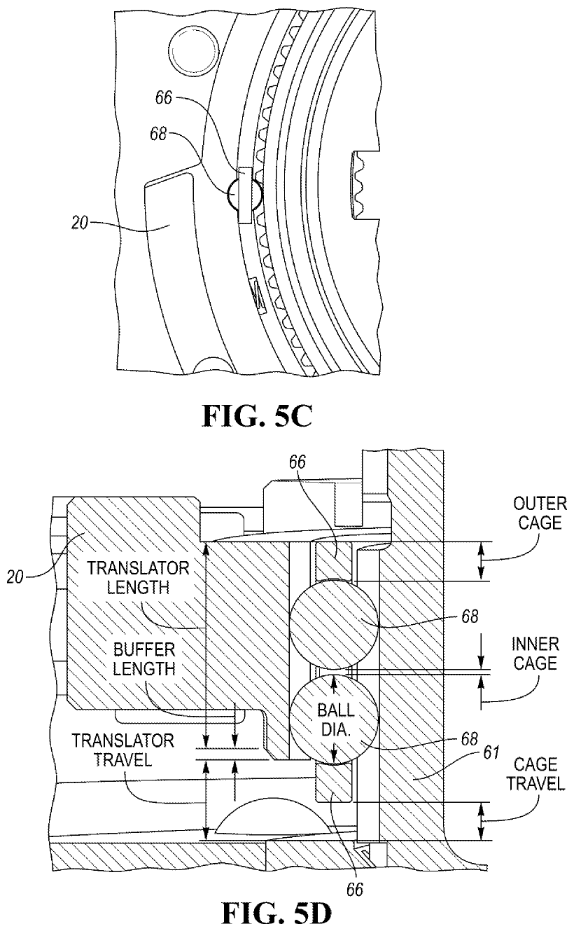

Referring now to FIGS. 5A, 5B, 5C, and 5D, bearing assembly 60 in accordance with embodiments of the present invention will be further described. Cage 66 is designed to retain balls 68 in assembly, allow translation in pure rotation, and maintain CL of ball under translator 20 in all conditions. The material of cage 66 may be stamped steel, 30% GF PEEK, or the like.

Regarding the geometry of cage 66, cage 66 may be a full circumference cage or a segmented cage. In the full circumference cage geometry, all balls are retained via one full circumference cage. Advantages of the full circumference cage may include unified motion of each ball set and ease of assembly. Disadvantages of the full circumference cage may include unsupported sections of cage 66 at speed may deform and increase friction during actuation; unsupported sections of cage 66 at speed may fracture from hoop stress; and difficultly in manufacturing with injection molding. To remedy disadvantages due to the unsupported sections, cage 66 may be made of steel with ribs.

In the segmented cage geometry, each raceway has an individual cage and the cage centripetal force will try to push it over the balls. Advantages of the segmented cage may include ease of manufacture (injection molding). Disadvantages of the segmented cage may include more difficult to assemble and the cages move independently of each other.

With reference to FIG. 5D, example calculations for bearing assembly 60 assembled at the interface between translator 20 and hub 61 are as follows:

| Stator (Hub) Length | 17 |
|---|---|
| Translator Length | 12.15 |
| Translator Travel | 4.5 |
| (Stator − Translator) | |
| Buffer Length | 0.25 |
| Diameter of Balls | 5 |
| Cage Travel (Translator Travel/2) | 2.25 |
| Max Cage Length | 14.75 |
| (Stator Length − Cage Travel) | |
| Cage Material Total | 4.75 |
| (Max Cage Length − 2*Ball | |
| Diameter) | |
| Assume Design Criteria that Ball CL Cannot Reach | |
| Buffer Zone | |
| Cage Outer Lengths | 2.25 |
| Cage Length between Balls | 0.25 |

The following tables provide details of a comparison of designs of the linear bearing assembly in accordance with embodiments of the present invention.

| Item | Hand Model #1 | Hand Model #2 |
|---|---|---|
| Cage Design | Full Circle Cage | Segmented Cage |
| Cage Material | ABS | ABS |
| Cage Mfg. Method | 3D Printing | 3D Printing |
| Balls | Stainless Steel 5 mm | Stainless Steel 5 mm |
| Ball Raceway | V-groove (initially for pin testing) | 5.10 mm diameter raceway |
| Ball/Ball Linear Gap | 1.00 mm | 0.25 mm |

| Item | Prototype #1 | Prototype #2 |
|---|---|---|
| Cage Design | Segmented Cage | Segmented Cage |
| Cage Material | PEEK | PEEK |
| Cage Mfg. Method | Injection Molding | Injection Molding |
| Balls | Stainless Steel 5 or 4 mm | Stainless Steel 5 or 4 mm |
| | (clutch dependent) | (clutch dependent) |
| Ball Raceway | 5.15 diameter raceway | 5.15 diameter raceway |
| Ball/Ball Linear Gap | Variable (clutch dependent) | Variable (clutch dependent) |

For reference, translator bearing force descriptions will be discussed. The translator force descriptions include (A) centripetal force, (B) angular acceleration, (C) imbalance, and (D) magnetic loading.

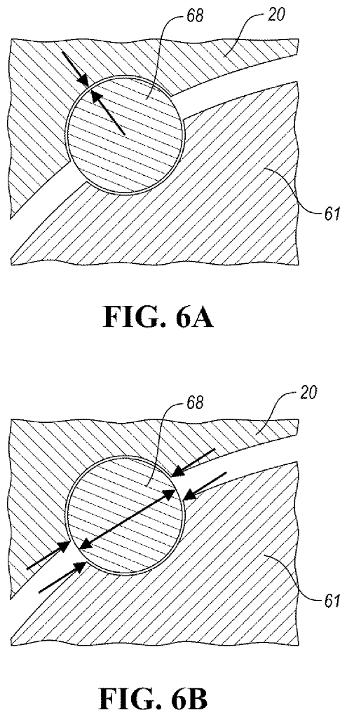

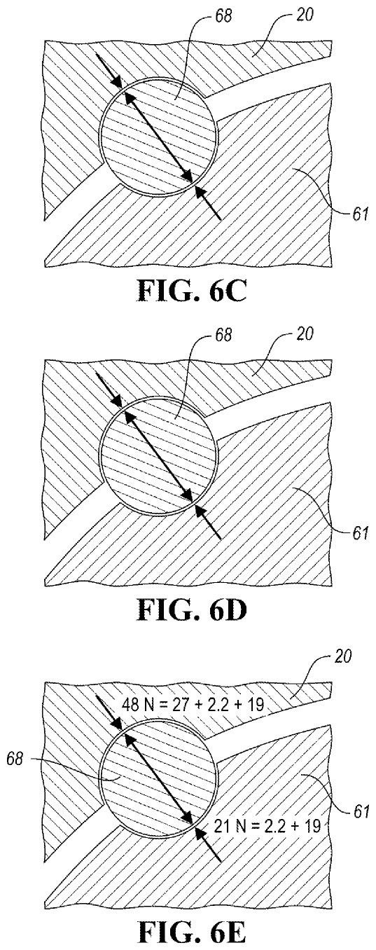

FIG. 6A is a drawing of a ball bearing 68 of the invented bearing assembly between translator 20 and hub 61 that is depictive of centripetal force. FIG. 6B is a drawing of a ball bearing 68 of the inventive bearing assembly between translator 20 and hub 61 that is depictive of angular acceleration. FIG. 6C is a drawing of a ball bearing 68 of the inventive bearing assembly between translator 20 and hub 61 that is depictive of imbalance. FIG. 6D is a drawing of a ball bearing 68 of the inventive bearing assembly between translator 20 and hub 61 that is depictive of magnetic loading.

The force descriptions have been tested to have the following values for radial loading of a version of the inventive bearing assembly at 9000 RPM:

| | |
|---|---|
| Centripetal Force | 27 N per ball |
| Angular Acceleration | N/A (only tangential) |
| Imbalance (10 g*mm): | 8.9 N across multiple balls; assume 2 rows |
| | carrying load (4 balls); 2.2 N per ball |
| Magnetic Loading | 75 N across multiple balls; assume 2 rows |
| (half air gap) | carrying load (4 balls); 19 N per ball |

FIG. 6E is a drawing of a ball bearing 68 of the inventive bearing assembly between translator 20 and hub 61 that is depictive of analysis for obtaining the above values.

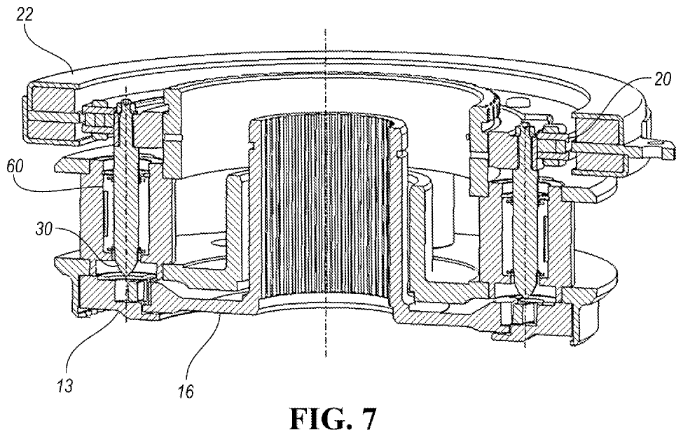

Referring now to FIG. 7, a cross-sectional view of a clutch assembly having a bearing assembly 60 in accordance with embodiments of the present invention is shown.

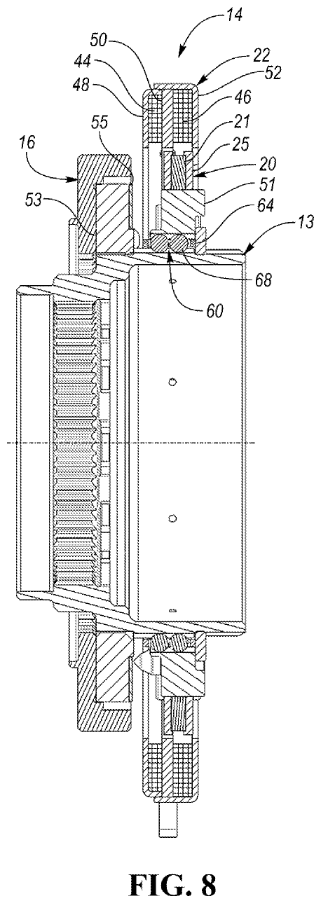

Referring now to FIG. 8, with continual reference to FIG. 1, particularly FIGS. 1D and 1E, a cross-sectional view of DCC 12 having a bearing assembly 60 in accordance with embodiments of the present invention is shown. Balls/cage component 64 and ball bearings 68 of bearing assembly 60 are shown in FIG. 8. As shown in FIG. 8, hub 61 is concentrically mounted over a portion of pocket plate 13 and bearing assembly 60 is concentrically mounted over a portion of hub 61. Carriage 51 of translator 20 is concentrically mounted over the bearing assembly 60 whereby bearing assembly 60 is positioned between the portion of hub 61 and carriage 51 of translator 20. As such, bearing assembly 60 is an interface between translator 20 and hub 61.

As described, with a clutch assembly such as a DCC, both the notch plate and the pocket plate are capable of rotating, in either a coupled or uncoupled state. The method to actuate the locking elements comes from an axial plunger(s) which is fixed to a translating mechanism (i.e., the translator). The translator fits concentrically over a hub of which there is a fixed connection thereto. The translator must be capable of relative movement in the axial direction with respect to the hub with very low resistance. However, the translator must also be able to transmit rotational torque to the hub. To permit the transmission of torque between the translator and the hub, while allowing for relative axial movement between the translator and the hub, the inventive bearing assembly is utilized at the translator/hub interface.

As described, the inventive bearing assembly may consist of any type of rolling element(s) (balls, rollers, needles, etc.). The rolling elements may or may not be entrapped by a cage. If a cage is used, then the cage may encompass the full circumference of the translator/hub interface with multiple raceways or the cage may be divided into individual segments for each individual raceway. The raceway features on the translator and the hub should complement each other and allow for the unrestricted motion of the rolling elements in the axial direction.

The interface between the translator and the hub can have a significant impact on the performance and capabilities of the actuation system. Specifically, if the resistance to motion is large enough, then the system may not be able to actuate at all. Or if the tolerance between the translator and the hub is not adequate, then the translator may become cocked and locked against the hub and unable to translate across the required range of motion. By utilizing the inventive bearing system, the resistance to motion is very low (e.g., rolling coefficient of 0.001) as compared to other designs (e.g., steel sliding coefficient of friction >0.2), allowing improved performance and functionality of the actuation system.

Alternative designs include other options for the translator/hub interface. One such interface would be a splined connection, wherein the translator and the hub have complementary castellation features that slide relative to each other in the axial direction and can transmit torque in the rotational direction. This design relies on sliding friction at the interface. As such, this design can severely hinder performance and functionality depending on usage.

Further, the inventive bearing assembly has been described herein for use with a two-position radial dynamic controllable clutch (“DCC”). Of course, the inventive bearing assembly can be deployed at the translator/hub interface in other DCC designs including three (or more) position DCCs and axial (i.e., planar) DCCs. More generally, the inventive bearing assembly can be employed at the interface between a translator of an actuator and a hub of any type of clutch assembly having the actuator.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A clutch assembly comprising:
a hub that is rotatable about a rotational axis;
a linear actuator having a translator mounted concentrically over the hub;
a bearing assembly at an interface between the translator and the hub, the bearing assembly permitting a transmission of torque between the translator and the hub while allowing for axial movement of the translator in a direction along the rotational axis relative to the hub; and
wherein the bearing assembly includes at least one rolling element.

2. The clutch assembly of claim 1 wherein:
the at least one rolling element is a ball bearing, a ball, a roller, or a needle.

3. The clutch assembly of claim 1 wherein:
the bearing assembly further includes a cage; and
the at least one rolling element is entrapped by the cage.

4. The clutch assembly of claim 3 wherein:
the cage encompasses a full circumference of the interface between the translator and the hub.

5. The clutch assembly of claim 4 wherein:
the cage includes a plurality of raceways, with at least one of the raceways having at least one rolling element retained therein.

6. The clutch assembly of claim 5 wherein:
the plurality of raceways includes at least three raceways.

7. The clutch assembly of claim 5 wherein:
the at least one of the raceways has two rolling elements retained therein.

8. The clutch assembly of claim 3 wherein:
the cage is divided into individual cage segments.

9. The clutch assembly of claim 8 wherein:
each cage segment includes a raceway, with at least one of the raceways having at least one rolling element retained therein.

10. The clutch assembly of claim 9 wherein:
the at least one of the raceways has two rolling elements retained therein.

11. The clutch assembly of claim 1 wherein:
the linear actuator further includes a stator having a stator coil; and
the translator arranged adjacent to the stator, the translator being axially movable, depending on polarity of electrical current of the stator coil, relative to the hub in the direction along the rotational axis between at least first and second positions.

12. The clutch assembly of claim 1 further comprising:
a coupling member supported for rotation about the rotational axis; and
the hub, with the translator concentrically mounted thereon, being mounted concentrically over a portion of the coupling member.

13. The clutch assembly of claim 12 wherein:
the linear actuator further includes a stator having a stator coil; and
the translator arranged adjacent to the stator, the translator being axially movable, depending on polarity of electrical current of the stator coil, relative to the hub and the portion of the coupling member in the direction along the rotational axis between at least first and second positions.

14. The clutch assembly of claim 12 wherein:
the coupling member is a pocket plate.

15. The clutch assembly of claim 12 wherein:
the coupling member is a notch plate.

16. A clutch assembly comprising:
first and second coupling members supported for rotation relative to one another about a rotational axis, and at least one locking member for selectively mechanically coupling the coupling members together to prevent relative rotation of the coupling members with respect to each other in at least one direction about the rotational axis;
a hub mounted concentrically over a portion of the first coupling member and being rotatable about the rotational axis;
a linear actuator having a stator and a translator, the stator including a stator coil to create a magnetic flux when the stator coil is energized with electrical current, the translator arranged adjacent to the stator and mounted concentrically over the hub and being rotatable about the rotational axis;
a bearing assembly at an interface between the translator and the hub, the bearing assembly permitting a transmission of torque between the translator and the hub while allowing for axial movement of the translator relative to the hub in a direction along the rotational axis, wherein the bearing assembly includes at least one rolling element; and
the translator being axially movable, depending on polarity of electrical current of the stator coil, relative to the hub in the direction along the rotational axis between at least first and second positions, the translator further configured to move the at least one locking member as the translator moves between the first and second positions whereby the first and second positions correspond to first and second operating modes of the coupling members.

17. The clutch assembly of claim 16 wherein:
the at least one rolling element is a ball bearing, a ball, a roller, or a needle.

18. The clutch assembly of claim 16 wherein:
the bearing assembly further includes a cage; and
the at least one rolling element is entrapped by the cage.

19. The clutch assembly of claim 16 wherein:
the first coupling member is a pocket plate and the second coupling member is a notch plate.

20. The clutch assembly of claim 16 wherein:
the first coupling member is a notch plate and the second coupling member is a pocket plate.
